(19) United States
(12) Patent Application Publication
(10) Pub. No.: US 2004/0221317 A1
(43) Pub. Date: Nov. 4, 2004

(54) Addressable tap with illegal channel detection functions

(76) Inventors: Yung-Liang Chang, KaoHsiung City (TW); Chih-Chou Shih, Taichung City (TW)

Correspondence Address: Judson K. Champlin, Westman, Champlin & Kelly, Suite 1600, 900 Second Avenue South, Minneapolis, MN, 55402-3319, US

(21) Appl. No.: 10/827,538

(22) Filed: Apr. 19, 2004

(30) Foreign Application Priority Data
Apr. 29, 2003 (CN) 03225809.7

(51) Int. Cl. H04N 7/16; H04N 7/173

(52) U.S. Cl. 725/127; 725/107; 725/145

(57) ABSTRACT

An addressable tap with illegal channel detection and cutting-off function consisting of a housing and a power supply module, a filter, a control module and RF switches inside said housing, which are electrically connected to said control module, is featured by: It also includes a tuning device, which can isolate random checking signals input at the front end of CATV channels. Said tuning device is electrically connected to said control module. Compared with the existing technology, the current invention has the following effects: high reliability and promptness in cutting off illegal signals; easy replacement of circuit board of the existing traditional non-addressable taps installed for enhancement to realize channel detection and cutting-off function. As this invention addressable tap can substitute the non-addressable taps in CATV network directly without separate wire laying, it is very easy in installation with very low enhancement costs.

### FIELD OF INVENTION

This invention is directed to the image communication technological sector, especially an addressable tap used in CATV for payment collection.

### BACKGROUND OF THE INVENTION

CATV is always interfered by illegal signals such as insertion of illegal advertisements, resulting in great losses by CATV operators. In order to avoid these losses, CATV operators add illegal channel detection and cutting-off function into the CATV network. Traditional method of realization of the function is by way of first detecting illegal signals and then issuing cut-off signals to the CATV source end through extra mobile or fixed communications system and finally cut off the transmission signals from the source end. This kind of detection and cutting-off method has the following disadvantages: extra mobile or fixed equipment or system is needed to cut off signals, reliability is not good and signal transmission cannot be cut off immediately.

### BRIEF SUMMERY OF THE INVENTION

Technical problems that the present invention aims to solve is avoiding the disadvantages in the existing technology by way of a new addressable tap, which can cut off illegal signals inserted immediately without any extra mobile or fixed equipment or system. The tap has very high reliability in cutting off illegal signals inserted.

The technical problems that this invention aims at can be solved by the following technical plan:

Design and use an addressable tap with illegal channel detection and cutting-off functions that consists of a housing and a power supply module, a filter, a control module and RF switches inside the housing. Said power supply module, filter and RF switches are electrically connected with said control module separately. Besides, the tap also consists of a tuning device able to detect and identify random checking signals inserted from the headend CATV channels, which is electrically connected with said control module.

Compared with the existing technology, the present invention has the following effects: high reliability and promptness in cutting off illegal signals; easy replacement of circuit board of the existing traditional non-addressable taps installed for enhancement to realize channel detection and cutting-off function. As this invention addressable tap can substitute the non-addressable taps in CATV network directly without separate wire laying, it is very easy in installation with very low enhancement costs.

### BRIEF DESCRIPTION OF THE DRAWINGS

FIG. 1 is a three-dimensional appearance sketch of the current invention addressable tap.

FIG. 2 is an electric sketch diagram of said addressable tap.

### PREFERRED EMBODIMENT

Further introduction is made in combination with the attached drawings.

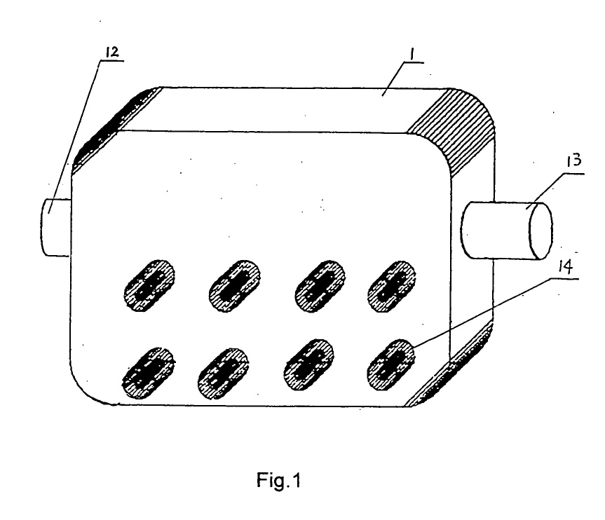

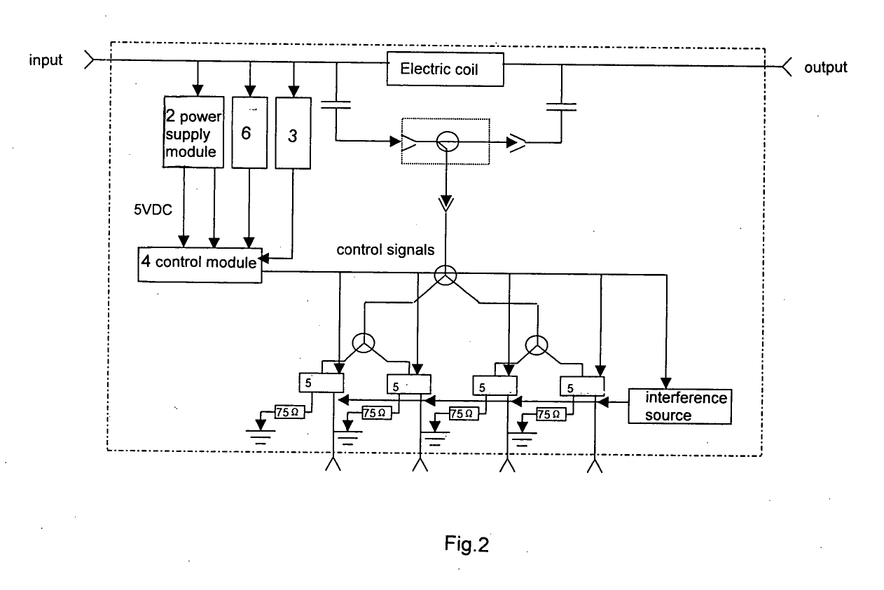

An addressable tap capable of illegal channel detection and cutting off functions as shown in FIGS. 1 and 2 consists of a housing 1 and a power supply module 2, a filter 3, a control module 4 and eight RF switches 5 (in order to make the figure clearer, only four of the eight RF switches are shown). Said power supply module 2, filter 3 and all the RF switches 5 are electrically connected with said control module 4. Besides, the tap also includes a tuning device 6 that is electrically connected with said control module 4 and said tuning device can detect and identify random checking signals inserted in the headend of CATV channels. Said tuning device is used to tune the circuit to the signal checking frequencies to be selected and is a device by existing technology, so no further descriptions will be made.

As shown in FIG. 2, AC voltage of 60V-90V, control signal at 110 MHz and CATV signals are input at the input terminal. Said power supply module 2 will convert AC voltage of 60V-90V to DC voltage of 5V for said control module 4. At the same time, the filter 3 will demodulate the control signals inside the input signals and transmit them to the control module 4, which can control the RF switches 5 or the signal source after receiving the control signals from the filter 3. CATV signals and control signals inside the input are transmitted to the RF switches 5 through capacitors.

At the headend of CATV network, tuned random identification signals are inserted during the time duration of vertical VBI (Vertical Blank Interleaved). When CATV signals go through the current invention addressable tap, said tuning device 6 will scan all the channels of CATV and isolate said random identification signals and send them to the control module 4. If one channel has no said random identification signals, then said control module 4 will confirm that the signals are not sent from the front end of the source, i.e., they are illegal signals. At the same time, the RF switches 5 are instructed to cut off the illegal signals.

As shown in FIG. 1, there is a main signal input terminal 12 connected to the precedent addressable tap at the left side of said housing 1 and a main signal output terminal 13 connected to the behind addressable tap on the right side of said housing and there are eight output terminals 14 connected with the users on the front side of said housing 1. Dimensions of said housing 1 are within plus minus 30% of standard housings of the existing non-addressable taps. As the shape and size of said housing are the same or compatible with the existing non-addressable taps used in CATV network, the faceplates of traditional taps installed can be replaced easily to realize enhancement of the function of sensing and cutting-off without the need to change the circuits or separate wire laying.

What is claimed is:

1. An addressable tap with illegal channel detection and cutting-off function consisting of a housing and a power supply module, a filter, a control module and RF switches inside said housing, which are electrically connected to said control module, is featured by:
It also includes a tuning device, which can isolate random checking signals input at the front end of CATV channels. Said tuning device is electrically connected to said control module.

2. An addressable tap with illegal channel detection and cutting-off functions as defined in claim 1 is featured by: said RF switches are eight in number.

3. An addressable tap with illegal channel detection and cutting-off functions as defined in claim 1 is featured by: there is a signal input terminal connected to the precedent addressable tap at the left side of said housing and a signal output terminal connected to the posterior tap on the right side of said housing and there are eight output terminals connected with the users on the front side of said housing.

4. An addressable tap with illegal channel detection and cutting-off functions as defined in claim 1 is featured by: dimensions of said housing are within plus minus 30% of standard housings of the existing non-addressable tap in order to replace the faceplates of traditional taps installed easily to realize enhancement of the function of sensing and cutting-off.
